(19) United States
(12) Patent Application Publication
(10) Pub. No.: US 2006/0067724 A1
(43) Pub. Date: Mar. 30, 2006

(54) Image forming unit

(75) Inventor: Ryuichi Sato, Ebina (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/071,118

(22) Filed: Mar. 4, 2005

(30) Foreign Application Priority Data
Sep. 24, 2004 (JP) 2004-277255

(51) Int. Cl. G03G 15/00

(52) U.S. Cl. 399/82

(57) ABSTRACT

An image forming unit performs an image forming process of forming images in sheets whose paper qualities are different from one another and a stapling process of stacking the plural sheets on which the images are formed and stapling them. The image forming unit includes a paper-quality obtaining section which obtains the paper quality of the sheet on which the image is formed in each sheet before the image forming process is performed; an accumulation section which accumulates a value based on the paper quality obtained by the paper-quality obtaining section in each of the plural sheets to be stapled before the stapling process is performed; and a stapling decision section which prohibits the stapling process when the value accumulated by the accumulation section exceeds a predetermined threshold.

### BACKGROUND OF THE INVENTION

1. Field of the Invention

The present invention relates to an image forming unit which performs an image forming process of forming images on sheets of paper whose types are different from one another and then performs a stapling process of stacking the plural sheets on which the images are formed to staple the stacked sheets.

2. Description of the Related Art

The function of an image forming apparatus which forms the image on the sheet has now diversified. One of those already in the market is the image forming unit which can perform the stapling process of stacking the plural sheets to staple the sheets after a process of folding the sheet on which the image is formed or after a process of punching the sheet in which the image is formed. There is a variety of paper qualities of the sheets on which the images are formed. Recently, in addition to plain paper, the image is also formed on thick paper whose thickness is larger than that of the plain paper. When the number of sheets to which the stapling process can be performed is determined based on the plain paper, a leg length of a staple will not be enough in the case where the thick paper is included in the plural sheets to which the stapling process is performed. Therefore, Japanese Patent Application Publication (JP-A) No. 2-38262 proposes the image forming unit in which, in order to perform the stapling process, the thickness of the whole of the stacked plural sheets is actually measured and the stapling process is prohibited when the leg length of the staple is not enough.

Recently, the formation of a full-color image becomes widespread and the full-color image is formed on coated paper whose surface is glossy in order to enhance image quality of the full-color image. The coated paper has a paper density higher than that of the plain paper. When the number of sheets to which the stapling process can be performed is determined based on the plain paper, shortage of drive force of the staple is generated even if the leg length of the staple is sufficient. Even if the technique described in JP-A 2-38262 is applied, the paper density cannot actually be measured, so that the shortage of the drive force of the staple is also generated.

In JP-A 2-38262, it is necessary to stack the sheets to actually measure the thickness of the whole of the stacked sheets, so that it takes a remarkable time to detect shortage of the leg length of the staple and the stapling process will be overtaken by previous processes. In the case of the use of the image forming unit, sometimes it is necessary to perform other processes except for the stapling process even if the stapling process cannot be performed, and sometimes it is desired that contents of the processes, the number of sheets, or the paper quality should be changed unless the stapling process can be performed. Therefore, the sooner the warning that the stapling process is prohibited is issued, the better.

### SUMMARY OF THE INVENTION

The present invention has been made in view of the above circumstances and provides an image forming unit which has a function of accurately deciding whether a stapling process can be performed even if the plural sheets of paper include various paper qualities.

In order to address the above problem, an image forming unit according to an aspect of the invention, which performs an image forming process of forming images in sheets whose paper qualities are different from one another and a stapling process of stacking the plural sheets on which the images are formed to staple the plural sheets, has a paper-quality obtaining section which obtains the paper quality of the sheet in which the image is formed in each sheet before the image forming process is performed; an accumulation section which accumulates a value based on the paper quality obtained in each of the plural stapled sheets by the paper-quality obtaining section before stapling process is performed; and a stapling decision section which prohibits the stapling process, when the value accumulated by the accumulation section exceeds a predetermined threshold.

With the above configuration, even if the plural sheets include various paper qualities, the accumulation section accumulates the value based on the paper quality and the stapling decision section decides whether the value accumulated by the accumulation section exceeds the predetermined threshold. Therefore, it is accurately decided whether the stapling process can be performed.

### BRIEF DESCRIPTION OF THE DRAWINGS

Embodiment of the present invention will be described in detail based on the following figures, wherein:

FIG. 1 shows a whole configuration of an image forming unit according to an embodiment of the invention when a sheet processing device is located in the center;

FIG. 2 shows a paper-type selection screen displayed on a liquid crystal touch panel shown in FIG. 1;

FIG. 3 shows a stapling-processing device shown in FIG. 1;

FIG. 4 shows a stapler section placed on a rail member which is neglected in FIGS. 1 to 3;

FIG. 5 is a functional block diagram showing a control section when a stapling decision process is performed;

FIG. 6 is a flowchart of a stapling decision process routine performed by the control section shown in FIG. 5; and

FIG. 7 shows a message display screen which is displayed on the liquid crystal touch panel shown in FIG. 1 through a process of Step S24 shown in FIG. 6.

### DETAILED DESCRIPTION OF THE INVENTION

Referring now to the accompanying drawings, an embodiment of the invention will be described.

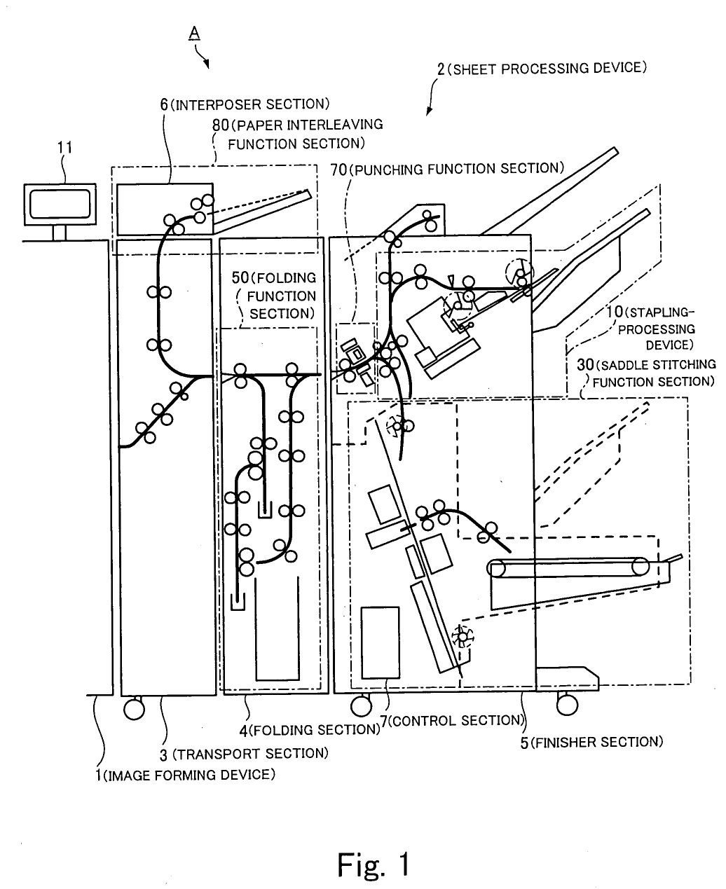

FIG. 1 shows a whole configuration of an image forming unit according to the embodiment of the invention when a sheet processing device is located in the center.

An image forming unit A shown in FIG. 1 includes an image forming device 1 which forms the image by electrophotographic method and a sheet processing device 2 which performs various post-processes to the sheet of paper in which the image is formed by the image forming device 1. The image forming device 1 forms the image made with a fixed toner image on the paper by performing an image forming process (copy). In the image forming process, a rotating surface of a toner image bearing body is charged, an electrostatic latent image is obtained on the surface of the toner image bearing body by irradiating the charged surface with an exposure light beam, the toner image is formed on the surface by developing the electrostatic latent image with toner, the toner image formed on the surface is transferred to a predetermined transferred surface, and finally the toner image is fixed onto the paper. The image forming device 1 can form the full-color image on the various paper qualities whose paper thickness and paper density are different from one another, and a liquid crystal touch panel 11 prepared as UI (User Interface) is included in the image forming device 1. When a user forms the image on the plural paper qualities, the user inputs the paper quality using the liquid crystal touch panel 11 in each sheet of a draft.

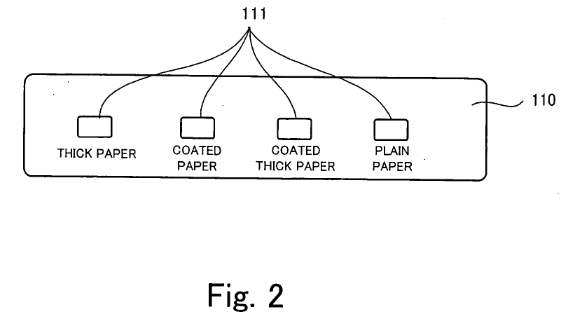

FIG. 2 shows a paper-quality selection screen displayed on the liquid crystal touch panel shown in FIG. 1.

The user selects the desired paper quality from the paper qualities (thick paper, coated paper, coated thick paper, and plain paper) displayed on a paper-type selection screen 110 shown in FIG. 2, and then the user presses down a paper-type determination button 111. For example, it is assumed that the draft is copied. The draft includes a first sheet formed by a cover sheet of the full-color image, second to 80th sheets formed by black-and-white images, 81st to 99th sheets formed by the full-color images, and a 100th sheet formed by a back cover of the black-and-white image. The coated thick paper is selected for the first sheet, the plain paper is selected for the second to 80th sheets, the coated paper is selected for the 81st to 99th sheets, and the thick paper is selected for the 100th sheet by selecting the paper-type selection screen 110 shown in FIG. 2.

The quality of paper will be defined as follows. Plain paper means reference paper which has a predetermined paper thickness and a predetermined paper density. Hereinafter the paper thickness of the plain paper is referred to as reference thickness, and the paper density of the plain paper is referred to as reference density. The thick paper means paper which has the paper thickness larger than the reference thickness while having the paper density equal to the reference density. The coated paper means paper which has the paper density larger than the reference density while having the paper thickness equal to the reference thickness. The coated thick paper means paper which has the same paper thickness as the thick paper while having the same paper density as the coated paper.

The sheet processing device 2 includes a transport section 3, a folding section 4, a finisher section 5, and an interposer section 6. The transport section 3 is connected to the image forming device 1. The folding section 4 performs a folding process to the sheet which is taken in by the transport section 3, and to which the image forming process is already performed. The finisher section 5 performs a predetermined final process to the sheet which has passed through the folding section 4. The interposer section 6 provides the thick paper which becomes the cover sheet of a brochure. The finisher section 5 includes a stapling-processing device 10 and a control section 7. The stapling-processing device 10 performs the stapling process. In the stapling process, the sheets in which the images are formed are stacked and stapled. The control section 7 controls the whole of the image forming unit A shown in FIG. 1. In the sheet processing device 2 including the above units, a saddle stitching process, the folding process, a punching process, and a paper interleaving process are performed in addition to the stapling process. In the saddle stitching process, the stacked plural sheets are book-bound by saddle-stitching the sheets with a saddle stitching function section 30 provided in the finisher section 5. In the folding process, the sheet is folded inside into three (C-shaped folding) or the sheet is folded outside into three (Z-shaped folding) with a folding function section 50 provided in the folding section 4. In the punching process, two holes or four holes are made by a punching function section 70 provided in the finisher section 5. In the paper interleaving process, interleaving paper, such as the thick paper and paper with a window, used for the cover sheet of a bundle of sheets is provided by a paper interleaving function section 80 formed by the interposer section 6 and the like.

Then, the stapling-processing device 10 mounted on the finisher section 5 of the sheet processing device 2 in FIG. 1 will be described in detail.

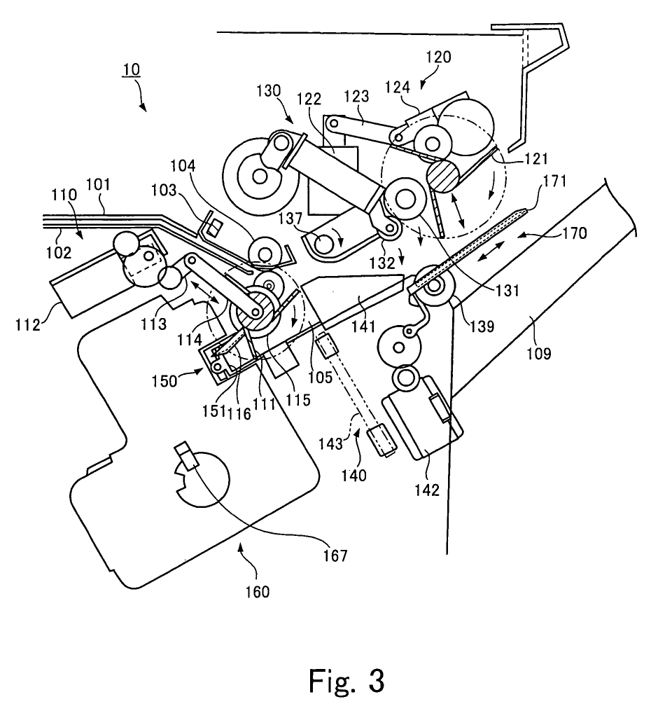

FIG. 3 shows the stapling-processing device shown in FIG. 1.

The stapling-processing device 10 shown in FIG. 3 includes conveying guides 101 and 102, a compiling exit sensor 103, a pair of conveying rollers 104, and a compiling tray 105. The conveying guides 101 and 102 guide the conveyed sheet. The compiling exit sensor 103 detects the conveyed sheet to output a signal for controlling operation of each function section. The pair of conveying rollers 104 sequentially delivers the sheet conveyed through the conveying guides 101 and 102. The sheets delivered by the pair of conveying rollers 104 are loaded on the compiling tray 105 while the sheets are stacked. The stapling-processing device 10 also includes an exit tray 109 on which the stapled bundles of sheets (brochure) are loaded while the bundles of the sheets are stacked. In the compiling tray 105, an end wall 151 is provided on the opposite side to a paper output direction. The end wall 151 is a reference wall when the bundles of sheets are aligned in a longitudinal direction (sheet conveying direction). Further, in the compiling tray 105, a crosswise reference wall (not shown) is provided in front of the device. The crosswise reference wall is the reference wall when the bundles of sheets are aligned in a crosswise direction (direction orthogonal to the sheet conveying direction).

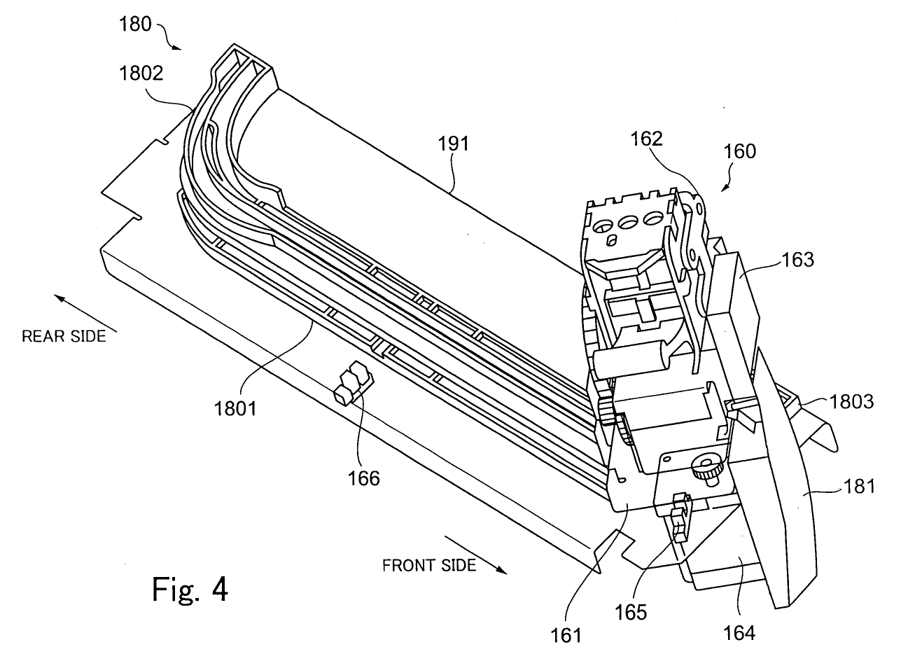

The stapling-processing device 10 includes a longitudinal direction alignment section 110, a longitudinal alignment assisting section 120, a bundled-sheets support and output section 130, a crosswise direction alignment unit 140, and an end wall section 150. The longitudinal direction alignment section 110 aligns the sheets in the longitudinal direction with respect to the sheet delivered to the compiling tray 105. The longitudinal alignment assisting section 120 assists the sheet alignment in the sheet conveying direction (longitudinal direction) by the longitudinal direction alignment section 110. In order to improve the alignment of the plural sheets stacked on the compiling tray 105, the bundled-sheets support and output section 130 holds down the sheets in performing the stapling processing and outputs the bundle of sheets after the stapling processing. The crosswise direction alignment unit 140 aligns the sheets in the direction orthogonal to the sheet conveying direction (crosswise direction) with respect to the sheet provided to the compiling tray 105. The end wall unit 150 includes an end wall 151 which becomes a wall to align the sheets during the sheets alignment in the longitudinal direction, and the end wall unit 150 has a mechanism which drives the end wall 151. The stapling-processing device 10 also includes a stapler section 160 and a shelf mechanism unit 170. The stapler section 160 performs the stapling process to the plural sheets provided to the compiling tray 105. The shelf mechanism unit 170 includes a shelf 171 which is a guide for supporting the sheets in the compiling tray 105, and the shelf mechanism unit 170 has the mechanism which drives the shelf 171. Further, the stapling-processing device 10 includes a rail member shown in FIG. 4, and the stapler section 160 is moved on the rail member.

The longitudinal direction alignment unit 110 will briefly be described. The longitudinal direction alignment unit 110 includes a compiling paddle 111, a compiling-paddle up and down solenoid 112, links 113 and 114, and control guides 115 and 116. The compiling paddle 111 presses the sheet sequentially provided to the compiling tray 105 against the end wall 151. The compiling-paddle up and down solenoid 112 vertically moves the compiling paddle 111 (retracting and advancing operation). The links 113 and 114 perform rotation or slide in conjunction with the compiling-paddle up and down solenoid 112. The control guides 115 and 116 assists the sheet alignment such that the strongly curled sheet is held down. The compiling paddle 111 is made of EPDM, and three blades are attached to one compiling paddle 111. The blade presses a rear end of the sheet provided to the compiling tray 105 against the end wall 151, thereby the rear ends of the sheets (longitudinal direction) are aligned.

Then, the longitudinal alignment assisting unit 120 will briefly be described. The longitudinal alignment assisting unit 120 includes a sub-paddle 121, a sub-paddle up and down solenoid 122, and links 123 and 124. The sub-paddle 121 assists the operation for pressing the sheet delivered to the compiling tray 105 against the end wall 151. The sub-paddle up and down solenoid 122 vertically moves the sub-paddle 121 (retracting and advancing operation). For example, the sub-paddle up and down solenoid 122 lifts a position of the sub-paddle 121 when the number of sheets becomes the predetermined number (50sheets). The links 123 and 124 vertically move the sub-paddle 121 in conjunction with the sub-paddle up and down solenoid 122. As with the compiling paddle 111, the sub-paddle 121 is made of EPDM, and three blades are attached to one sub-paddle 121. The blade assists the longitudinal alignment of the sheets delivered to the compiling tray 105.

Then, the sheet-bundle support and output section 130 will briefly be described. The sheet-bundle support and output section 130 includes an ejection roller 131 and a hold-down roller 132. The ejection roller 131 is pressed against an opposed roller 139, and the ejection roller 131 supports the sheet and outputs the bundle of sheets. For example, the hold-down roller 132 holds down the sheet folded in the Z shape in the vicinity of the folded portion. The hold-down roller 132 is provided between the compiling tray 105 and the ejection roller 131 (opposite direction to the sheet output direction). The hold-down roller 132 is configured to be able to hold down the sheet in the vicinity of the folded portion, for example, when the sheet having an A3 size is folded in the Z shape to become the sheet having an A4 size. The ejection roller 131 and the hold-down roller 132 are rotated about a rotating center shaft 137. The plural sheets, which have been formed in the bundle of sheets by stapling the sheets on the compiling tray 105, are sandwiched between the ejection roller 131 and the opposed roller 139. The ejection roller 131 is rotated by an ejection motor (not shown) to output the bundle of sheets toward the exit tray 109. After the bundle of sheets is output, the ejection motor reversely rotates the ejection roller 131 at timing when the first sheet is conveyed to the empty compiling tray 105 so that the sheet is conveyed toward the compiling-tray direction which is of the opposite direction to the output direction.

Then, the crosswise direction alignment unit 140 will briefly described. The crosswise direction alignment unit 140 includes a tamper 141, a tamper motor 142, and a belt 143. The tamper slides in the direction orthogonal to the sheet conveying direction to perform the crosswise alignment in each sheet from rear side of the device toward the front side to the sheet delivered to the compiling tray 105. The tamper motor 142 is a drive source which reciprocally moves the tamper 141. The belt 143 transmits drive force of the tamper motor 142 to the tamper 141.

Then, the stapler section 160 will be described.

FIG. 4 shows the stapler section placed on the rail member which is neglected in FIGS. 1 to 3.

The stapler section 160 shown in FIG. 4 is moved on a rail member 180 which connects a staple disposal position and plural stapling-processing positions. A staple center position sensor 166 is provided at a central position in the extending direction of the rail member 180. The staple center position sensor 166 detects whether the stapler section 160 is located at the central position or not. The rail member 180 is formed on a base 191, and the rail member 180 has a linear portion 1801 and R-shaped portions 1802 and 1803 which are connected to ends of the linear portion 1801 respectively. FIG. 4 shows the stapler section 160 located in the right-side R-shaped portion 1803. The stapler section 160 shown in FIG. 4 is located at the staple disposal position which is outside a chassis of the stapling-processing device, i.e. outside the chassis of the finisher section 5 shown in FIG. 1. The staple disposal position shown in FIG. 4 is also one of the plural stapling-processing positions.

The stapler section 160 includes a stapling unit 161, a cutter unit 162, a storage unit 163, a stapler moving motor 164, and a stapler moving sensor 165. The stapling unit 161 actually performs the stapling. The cutter unit 162 cuts a leading edge of the staple by the amount according to the thickness of the bundle of sheets. The storage unit 163 houses the leading edge of the staple cut by the cutter unit 162. The stapler moving motor 164 is a stepping motor which becomes the drive source of the stapler section 160 when the stapler section 160 is moved on the rail member 180. The stapler moving sensor 165 detects that the stapling unit 161 performs the movement operation of the staple. As shown in FIG. 3, the stapler section 160 also includes a stapling operation detection sensor 167 which detects that the stapling unit 161 performs the stapling operation.

Further, the stapler section 160 includes a duct chute 181 and a staple collection box (not shown). The duct chute 181 and the staple collection box are provided at the staple disposal position, and the staple collection box 182 is detachable. The leading edge of the staple housed in the storage unit 163 is put in the staple collection box from the stapler section 160 moved to the staple disposal position through the duct chute 181.

Then, the control section 7 which controls the whole of the image forming unit A shown in FIG. 1 will be described in detail.

A stapling decision process for deciding whether the stapling process can be performed is performed in the control section 7 shown in FIG. 1.

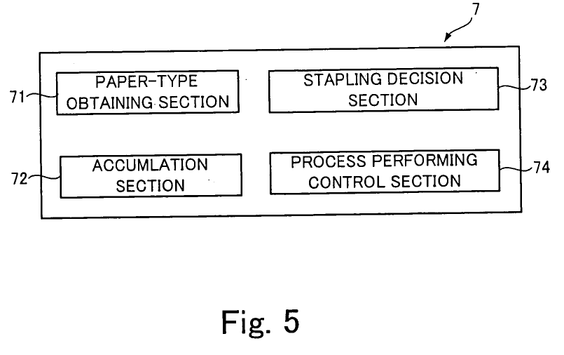

FIG. 5 is a functional block diagram showing the control section when the stapling decision process is performed.

The control section 7 shown in FIG. 5 includes a paper-quality obtaining section 71, an accumulation section 72, a stapling decision section 73, and a process performing control section 74. The paper-quality obtaining section 71 obtains the paper quality of each sheet in which the image if formed. The paper quality is inputted from the liquid crystal touch panel 11. Once the paper quality of the sheet is obtained by the paper-type obtaining section 71, the accumulation section 72 accumulates a value based on the paper quality obtained by the paper-type obtaining section 71 in each sheet of the stapled plural sheets. Namely, the accumulation section 72 accumulates the value based on the paper quality before the stapling process is performed. When the accumulation section 72 accumulates the value based on the paper quality obtained in each sheet by the paper-type obtaining section 71, the accumulation section 71 may accumulate the value in which a coefficient based on the paper quality is multiplied, the value in which the coefficient based on the paper density is multiplied, or the value in which the coefficient based on the paper thickness is multiplied. A predetermined threshold based on the limiting number of sheets which can be stapled is set in the stapling decision section 73. When the value accumulated by the accumulation section 72 exceeds the threshold, the stapling decision section 73 decides that the stapling process cannot be performed and prohibits the stapling process intended to be performed. At that point, the stapling decision section 73 also prohibits the image forming process when the image forming process is not started yet, and the stapling decision section 73 terminates the image forming process when the image forming process is in progress. In the case where the stapling process cannot be performed and in the case where a response is adopted such that the number of sheets or the paper quality should be changed, sometimes the unnecessary sheet is generated in the sheets in which the images are formed when the image forming process is continued. However, the unnecessary sheets can be prevented from generating by prohibiting the image forming process, and the unnecessary sheets can be prevented from generating by terminating the image forming process even if the image forming process is being performed. A job which directs the performance of various processes, such as the image forming process and the stapling process, is inputted to the process performing control section 74, when the user operates the liquid crystal touch panel 11. The process performing control section 74 controls various processes according to the inputted job.

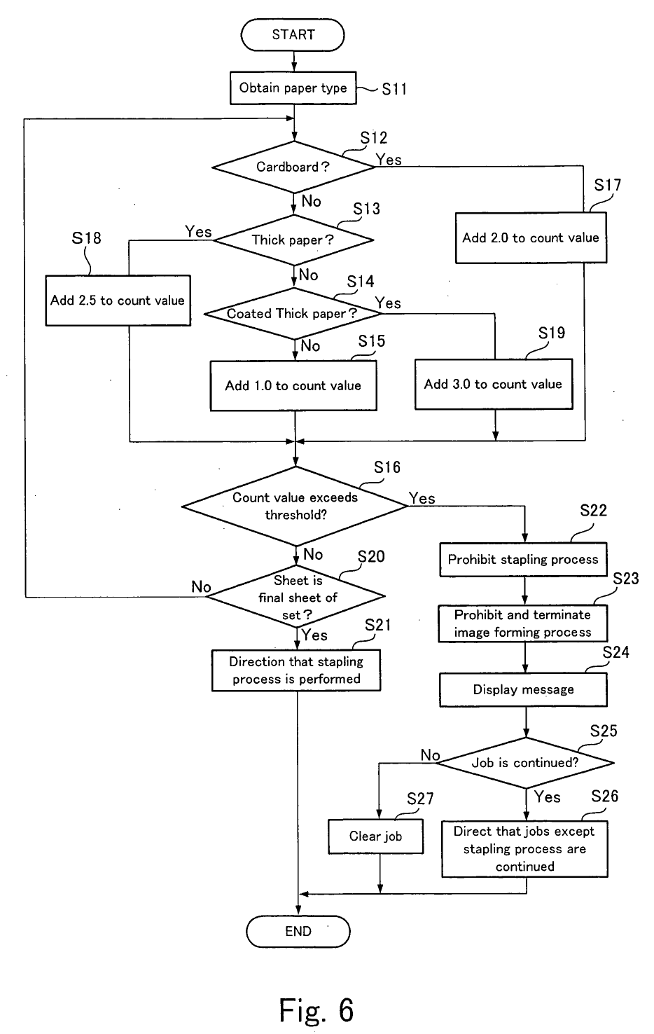

FIG. 6 is a flowchart of a stapling decision process routine performed by the control section shown in FIG. 5.

When the job including the direction that performs the stapling process is inputted to the process performing control section 74 shown in FIG. 5, the stapling decision process routine shown in FIG. 6 is started.

The paper-quality obtaining section 71 obtains the paper quality of the sheet to which the image forming process is performed with respect to each sheet (Step S11). The accumulation section 72 makes the decision of the paper quality about each of the stapled plural sheets based on the paper quality obtained in Step S11. Hereinafter the plural sheets are referred to as “set.” Namely, in Step S12, it is decided whether the paper quality is the thick paper or not. When the paper quality is not the thick paper in Step S12, it is decided whether the paper quality is the coated paper or not (Step S13). When the paper quality is not the coated paper in Step S13, it is decided whether the paper quality is the coated thick paper or not (Step S14). When the accumulation section 72 decides that the paper quality is not the coated thick paper in Step S14, the accumulation section 72 decides that the paper quality is the plain paper, and the accumulation section 72 adds 1.0 to the accumulation value (count value) in Step S15. Then, the stapling decision section 73 decides whether the count value exceeds the predetermined threshold based on the limiting number of sheets to which the stapling process can be performed or not (Step S16).

In the case of the thick paper, Step S12 goes to Step S17 to add 2.0 to the count value. 2.0 is the double value of 1.0 which is added in Step S15. Then, the flow goes to Step S16. In the case of the coated paper, Step S13 goes to Step S18 to add 2.5 to the count value. 2.5 are 2.5 times 1.0 which is added in Step S15. Then, the flow goes to Step S16. In the case of the coated thick paper, Step S14 goes to Step S19 to add 3.0 to the count value. 3.0 are 3.0 times 1.0 which is added in Step S15. Then, the flow goes to Step S16. Thus, the accumulation section 72 adds the value of 2.0 larger than the value of 1.0 of the plain paper when the accumulation section 72 adds the value of the thick paper. The accumulation section 72 adds the value of 2.5 larger than the value of 2.0 of the thick paper when the accumulation section 72 adds the value of the coated paper. The accumulation section 72 adds the value of 3.0 larger than the value of 2.5 of the coated paper when the accumulation section 72 adds the value of the coated thick paper.

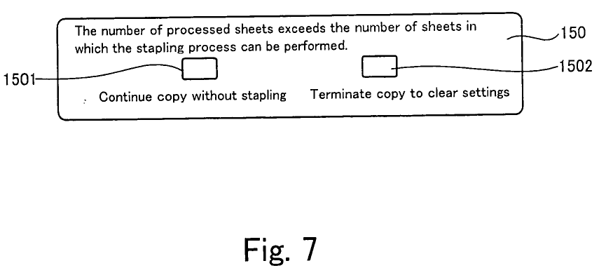

When the stapling decision section 73 decides that the count value is not more than the threshold in Step S16, the accumulation section 72 decides whether the sheet about which the decision of the paper quality is made is the final sheet of the set or not (Step S20). When the sheet about which the decision of the paper quality is made is not the final sheet, the flow is returned to Step S12. When the sheet about which the decision of the paper quality is made is the final sheet, the process performing control section 74 directs the stapling-processing device 10 to perform the stapling process (Step S21), and the control section 7 shown in FIG. 7 ends the process routine. The stapling-processing device 10 performs the stapling process after the final sheet of the set is conveyed to the compiling tray 105.

When the stapling decision section 73 decides that the count value exceeds the threshold in Step S16, the stapling decision section 73 prohibits the stapling-processing device 10 from performing the stapling process (Step S22). At the same time, the stapling decision section 73 prohibits the image forming process unless the image forming process is started, and the stapling decision section 73 terminates the image forming process even if the image forming process is being performed (Step S23). Further, the stapling decision section 73 causes the liquid crystal touch panel 11 shown in FIG. 1 to display a message (Step S24).

In the case where a response such as the change in the number of sheets or the paper quality is adopted unless the stapling process can be performed, sometimes continuation of the image forming process generates the unnecessary sheet in the sheets in which the images are formed. However, the unnecessary sheet can be prevented from generating by terminating the image forming process.

FIG. 7 shows a message display screen which is displayed on the liquid crystal touch panel shown in FIG. 1 through the process of Step S24 shown in FIG. 6.

The message that the stapling process is prohibited is displayed on the upper portion of a message display screen 150 shown in FIG. 7. Icon buttons 1501 and 1502 which direct whether the job is cancelled or not are displayed under the message. Namely, with the icon button 1501 displayed on the left side of FIG. 7, a user directs that the job is continued, and with the icon button 1502 displayed on the right side of FIG. 7, the user directs that the job is cancelled. When the user presses down the icon buttons 1501 and 1502, whether the job is continued or cancelled is transmitted to the process performing control section 74.

In Step S25 shown in FIG. 6, the process performing control section 74 decides whether the job is continued or not. When the job is continued, the process performing control section 74 directs that out of processes in the received jobs, the processes such as the image forming process, the folding process, and the punching process except for the stapling process should be continuously performed (Step S26). The control section 7 shown in FIG. 5 ends the process routine. When the job is not continued, the process performing control section 74 clears the received jobs (Step S27), and the control section 7 shown in FIG. 5 ends the process routine.

As described above, according to the image forming unit of the embodiment, even if the plural sheets include the thick paper, the coated paper, and the coated thick paper in addition to the plain paper, the accumulation section 72 accumulates the value based on the paper quality, and the stapling decision section 73 decides whether the value accumulated by the accumulation section 72 exceeds the predetermined threshold based on the limiting number of sheets in which the stapling process can be performed, so that whether the stapling process can be performed or not can be accurately decided.

The plain paper, the thick paper, the coated paper, and the coated thick paper are cited as examples of the paper quality in the embodiment. However, the paper quality is not limited to the above four paper qualities. For example, in the case of the use of the sheets of thick paper whose paper thicknesses are different from one another, the paper quality of the thick paper may be divided into sub-paper qualities according to the paper thickness. In the case of the use of the sheets of coated paper whose paper densities are different from one another, the paper quality of the coated paper may be divided into sub-paper qualities according to the paper density.

The foregoing description of the embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2004-277255 filed on Sep. 24, 2004, including specification, claims, drawings and abstract is incorporated herein by reference in its entirety.

What is claimed is:

1. An image forming unit that performs an image forming process of forming images on sheets whose paper qualities are different from one another and a stapling process of stacking the plurality of sheets on which the images are formed and stapling the plurality of sheets, the image forming unit comprising:
a paper-quality obtaining section that obtains the paper quality of the sheet on which the image is formed in each sheet before the image forming process is performed;
an accumulation section that accumulates a value, based on the paper quality obtained by the paper-quality obtaining section in each of the plurality of sheets to be stapled, before it is performed; and
a stapling decision section that prohibits the stapling process before it is performed when the value accumulated by the accumulation section exceeds a predetermined threshold.

2. The image forming unit according to claim 1, wherein the accumulation section accumulates the value that is a result of multiplication of a predetermined value by a coefficient based on the paper quality obtained by the paper-quality obtaining section.

3. The image forming unit according to claim 2, wherein the paper quality obtained by the paper-quality obtaining section is a paper density.

4. The image forming unit according to claim 2, wherein the paper quality obtained by the paper-quality obtaining section is a paper thickness.

5. The image forming unit according to claim 1, wherein the accumulation section accumulates the value larger than the value of plain paper, when the accumulation section accumulates the value of coated paper which has the paper density higher than the paper density of the plain paper having a predetermined paper density.

6. The image forming unit according to claim 1, wherein the accumulation section accumulates the value larger than the value of the plain paper, when the accumulation section accumulates the value of thick paper which has the paper thickness larger than the paper thickness of the plain paper having the predetermined paper thickness.

7. The image forming unit according to claim 1, further comprising a warning section that issues a warning that the stapling process is prohibited at the time when the value accumulated by the accumulation section exceeds the predetermined threshold.

8. The image forming unit according to claim 1, wherein the stapling decision section terminates the image forming process when the value accumulated by the accumulation section exceeds the threshold while performing the image forming process.

9. An image forming unit according to claim 1, further comprising:
a process performing control section that receives a job for directing the performance of various processes including the image forming process and the stapling process and controls the performance of the various processes according to the received job; and
an interface that allows a user to direct whether the job be cancelled when the value accumulated by the accumulation section exceeds the predetermined threshold,
wherein the process performing control section clears the received job, when the direction that the job be canceled is issued from the user through the interface, and
the process performing control section continuously performs the processes except for the stapling process that are directed to be performed by the received job, when the direction that the job be continued is issued from the user through the interface.
